(19) United States
(12) Patent Application Publication
(10) Pub. No.: US 2024/0223996 A1
(43) Pub. Date: Jul. 4, 2024

(54) MULTI-TENANT ARCHITECTURE FOR POSITION LOCATION SERVICE (PLS)

(71) Applicant: DISH WIRELESS L.L.C., ENGLEWOOD, CO (US)

(72) Inventors: Mehdi Alasti, Reston, VA (US); Kazi Bashir, Lewisville, TX (US); Siddhartha Chenumolu, Broadlands, VA (US)

(21) Appl. No.: 18/091,184

(22) Filed: Dec. 29, 2022

(51) Int. Cl. H04W 4/029; G06F 9/54; H04W 64/00

(52) U.S. Cl. CPC H04W 4/029; G06F 9/547; H04W 64/00

(57) ABSTRACT

A multiple tenant architecture for providing location services in a wireless network. A method or system electronically defines, for each tenant of a plurality of tenants of the wireless network, customization parameters for one or more location services or location services systems. The customization parameters specify attributes or policies of the positioning technology used to locate the User Equipment (UE) devices and attributes or policies of the core network.

### TECHNICAL FIELD

This patent application relates to mobile wireless communication systems, and more particularly relates to providing position location services in a wireless network that supports multiple tenants.

### BACKGROUND

The Third Generation Partnership Project (3GPP) working group Fifth Generation (5G) wireless technology provides a broad range of wireless services delivered to enterprises and the end user across multiple access platforms and multi-layer networks. 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible and virtualized RAN with interfaces creating additional data access points.

The 3rd Generation Partnership Project (3GPP) also develops protocols for mobile telecommunications and has developed a standard for 5G. The 5G architecture is based on what is called a Service-Based Architecture (SBA), which implements IT network principles and a cloud-native design approach. In this architecture, each Network Function (NF) offers one or more interfaces to other NFs via Application Programming Interfaces (API). Network function virtualization (NFV) decouples software from hardware by replacing various network functions such as location management, firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as the Open RAN (O-RAN) Alliance. This enables flexibility, provides open interfaces and open source development, ultimately to ease the deployment of new features and technology with scale. The O-RAN Alliance objective is to allow multi-vendor deployment with off-the shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

5G network functions may be completely software-based and designed as cloud-native, meaning that they're agnostic to the underlying cloud infrastructure, allowing higher deployment, agility and flexibility. With the advent of 5G, industry experts defined how the 5G core (5GC) network should evolve to support the needs of 5G New Radio (NR) and the advanced use cases enabled by it. The 3GPP develops protocols and standards for telecommunication technologies including RAN, core transport networks and service capabilities. 3GPP has provided complete system specifications for 5G network architecture which is much more service oriented than previous generations. 5G network slicing enables 5G mobile network operators (MNOs) to build and manage their network to meet and exceed the emerging requirements from a wide range of users or enterprises (i.e., tenants) sharing the same physical network resources of the MNO.

### SUMMARY OF PREFERRED EMBODIMENTS

The techniques described herein are an improved approach to providing services to multiple tenants of a wireless network to locate the geographic position of one or more User Equipment (UE) devices.

According to an example embodiment, a method or system electronically defines, for each tenant of a plurality of tenants of the wireless communication network, customization parameters for one or more location services or location services systems. The customization parameters specify attributes of at least the positioning services and the core network.

More particularly, a Multi-Tenant Location as a Service (MT-LaaS) may electronically define, for each of several tenants, at least one attribute or policy for a positioning technology that is used to determine geographic position data of one or more User Equipment devices (UEs). The MT-LaaS may also enable each tenant to define attributes or policies for a network core that is used by the MT-LaaS service to provide the customized location services.

In some embodiments, the network core may be provided by a wireless network slice.

The MT-LaaS may be provided by a first business entity and the network core by a second business entity.

Each tenant may also specify one or more attributes or policies for storage, retention, and backup of the geographic position data.

The positioning technology specified may, for example, include those based on Multi-Cell Round Trip Time (MC-RTT), Cell-ID, E-CID, DL-TDOA, UL-TDOA, AoA, AOD, A-GPS, Google ELS, Apple HELO, and NextNav.

In one example, the at least one attribute of the positioning technology includes specifying whether the positioning technology is observable by the UEs.

Each tenant may also specify other attributes or policies of the MT-LaaS such as related analytics, charging, alarms, key performance indicators, or geographic position data protection and retention.

The MT-LaaS may operate using a Gateway Mobile Location Center (GMLC) node of the wireless telecommunication network that supports network slicing.

Optionally, a Location Management Function (LMF) of the wireless telecommunication network may be one that also supports network slicing.

At least one attribute or policy for the network core may specify disaggregated elements of an Open Radio Access Network to be used, and whether such elements Are operated by the tenant.

In further aspects, the policies may electronically define an Application Programming Interface (API) for use by the tenant to interact with the MT-LaaS, such as via a Common Application Programming Interface Function (CAPIF).

### BRIEF DESCRIPTION OF THE DRAWINGS

Additional novel features and advantages of the approaches discussed herein are evident from the text that follows and the accompanying drawings, where:

FIG. 1 is a high level diagram of a multi-tenant location as a service (MT-LaaS) system according to one embodiment.

FIG. 2 illustrates pathways between various wireless telecommunication network functions and components that may be used to implement the MT-LaaS system.

FIG. 3 shows how attributes of the MT-LaaS service may be configured by a tenant and maintained using an MT-LaaS policy engine and data store.

FIG. 4 is an example flow for how the MT-LaaS service may define tenant-specific attributes and policies.

FIG. 5 illustrates an example positioning policies data structure.

FIG. 6 illustrates an example analytics policies data structure.

FIG. 7 illustrates an example charging policies data structure.

FIG. 8 illustrates an example alarm/KPI data structure.

FIG. 9 illustrates an example storage/retention data structure.

FIG. 10 illustrates an example core options data structure.

FIG. 11 illustrates an example Application Programming Interface (API) attributes data structure.

FIG. 12 shows an example implementation of a data processing system for implementing embodiments of one or more of the features of the MT-LaaS system described herein.

### DETAILED DESCRIPTION OF PREFERRED EMBODIMENTS

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof.” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

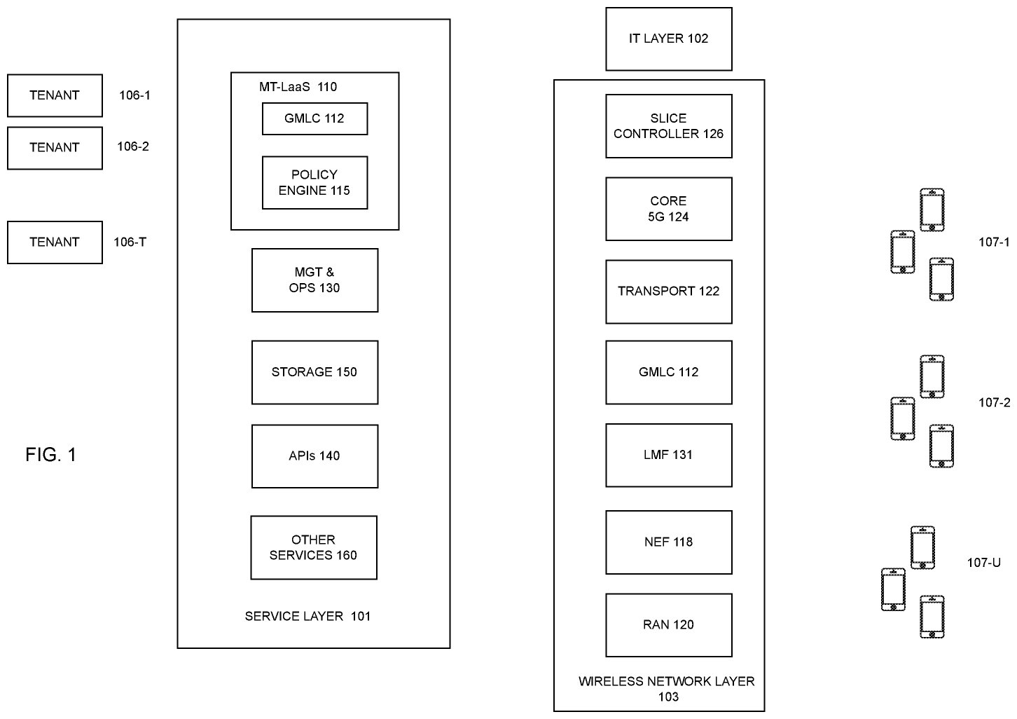

FIG. 1 illustrates a diagram of an example system 100 that implements Multi-Tenant Location as a Service (MT-LaaS) 110 in a wireless communication network.

The system 100 enables a provider of the MT-LaaS 110 to support location based services customized to one or more tenants (multi-tenancy) 106-1, 106-2, . . . 106-t (collectively tenants 106). Each tenant is able to specify custom attributes and/or policies of the services deployed to location selected User Equipment (UE) UEs 107-1, 107-2, . . . , 107-u (collectively, the UEs 107) as well as attributes and policies of the wireless network that delivers these services. It should be understood that a given tenant, such as tenant 106-2, may typically be associated with deploying the MT-LaaS service 110 a given group of UEs such as UEs 107-2.

The example system 100 is a multi-tier system implemented with a service layer 101, operations and information technology (IT) layer 102 and wireless network layer 103. Each of the service layer 101, operations and information technology (IT) layer 102 and wireless layer 103 contributes to the definition and deployment of the attributes of the location services with distinct tasks.

The service layer 102 may include a Gateway Mobile Location Center (GMLC) 112 that implements the customized location services as a Multi-Tenant Location as a Service (MT-LaaS) service 110. The GMLC 112 may support network slicing as an option for the tenants to specify attributes of the core network on which the MT-LaaS 110 will be deployed. As explained in further detail below, the provider of the MT-LaaS 110 may or may not be the same provider of the GMLC 112 or even the provider of any other aspect of the service layer 101, IT layer 102, or network layer 103.

The GMLC 112 may interface with a Location Management Function (LMF) 131 implemented as part of the network functions layer 103. Tenants 106 may include various types of business enterprises, government entities, institutions, universities, wireless network business entities such as Mobile Network Operators (MNOs) or Mobile Virtual Network Operators (MVNOs). The tenants 106 may or may not share the underlying physical wireless network(s) 103, however, each tenant 106 obtains wireless location services for respective sets of wireless User Equipment (UE) UEs 107-1, 107-2, . . . , 107-u via the MT-LaaS 110.

The service layer 101 provides a unified vision of the service requirements. Each service is formally represented as a service instance, which may embed the necessary network characteristics in the form of Service Level Agreement (SLA) requirements that are expected by each tenant 106 to be fully satisfied by a suitable function of the MT-LaaS 110.

The operations and IT layer 102 works with the wireless network layer 103 to deploy the MT-LaaS 110 for each tenant 106 according to their service instance requests. The operations and IT layer 102 may perform other functions such as usage monitoring, or may governs control plane functions via rules defined according to policies as more fully explained below. The IT layer 102 may include Business Support Systems (BSS), which may include business and/or customer-facing functionality and Operations Support Systems (OSS), which in turn may include information processing systems used by network operators to manage the network.

Network layer 103 includes a Radio Access Network (RAN) 120, which implements physical infrastructure to enable connecting the UEs 107. The RAN 120 implements specific, radio access technolog(ies) and Network Functions (NFs) that provide connections from the UEs 107 to the core network 124 (which may be a 5G core). Network layer 103 also includes other NFs, such as a Location Management Function 131 and Network Exposure Function 118. The NFs may embody behaviors and interfaces as specified in well-known standards such as defined in the European Telecommunications Standards Institutes (ETSIs) Third Generation Partnership Project (3GPP), Fifth Generation (5G) Releases.

In some embodiments, multiple network functions, including the LMF 131, may be layered over the virtual network infrastructure and chained together to create an end-to-end network slice instance that reflects the network characteristics requested by the service layer 101.

Regardless of the details of the configuration of the service layer 101 and wireless network layer 103, these are implemented using available resources includes a heterogeneous set of infrastructure components such as data centers (storage and computation capacity resources), devices enabling network connectivity such as routers (networking resources) and base stations (radio bandwidth resources).

As mentioned above, the service layer 101 provides Multi-Tenant Location as a Service (MT-LaaS) 110 according to various policies and attributes. This may involve coordination between the GMLC 112 and the LMF 131, expressed in terms of Service Level Agreement (SLA) requirements, with suitable network functions capable of satisfying the service requirements and constraints of each individual tenant 106. These requirements and constraints will be different for each individual tenant 106 and may be specified as MT-LaaS policies further coordinated by an MT-LaaS policy engine 115.

The service layer 101 may also implement management and operations functions 130, Application Specific Interface(s) 140, and storage services 150. Service layer 101 may also provide other services 160 not related to MT-LaaS to the tenants 106.

An optional network slice controller 126 is dedicated to slice management and configuration of network slices that may support customized MT-LaaS. In particular, the network slice controller 126 may monitor and manage the functionalities between the service layer 101, operations and IT layer 102 and network layer 103 in order to efficiently coordinate the coexistence of multiple slices that each support MT-LaaS services 110 as customized for each tenant 106.

The network slice controller 126, if present, thus provides end-to-end service management that includes mapping of the various service instances needed by service layer 101 including the MT-LaaS service 110. The network slice controller 126 may include a network orchestrator 128, which interfaces with the various functionalities performed by the service layer 101, operations and IT layer 102 and network layer 103 to coherently manage each slice request. The benefit of such an orchestrator element 128 is that it enables an efficient and flexible creation of network slices for multi-tenant location based services that can be reconfigured during their life cycles.

In one example, the network slice controller 126 may map location data for the UEs 107 associated with each respective tenant 106 to a respective specific network slice defined for the tenant, including positioning technologies, analytics policies and attributes, data retention policies, security policies, network core attributes, Business Support System (BSS) data, and/or operation support system (OSS) data, including alarms and key performance indicators (KPIs).

The network slice controller 126 may also provide virtualization of the physical wireless network 103 resources in order to simplify the resources management operations performed to allocate network functions, including the LMF 131. Furthermore, the network slice controller 126 may provide slice life-cycle management that includes slice performance monitoring across all the three layers in order to dynamically reconfigure each slice to accommodate possible SLA requirements modifications specific to a particular slice (on a per slice basis), including, but not limited to: geographical positioning and location requirements, positioning and location analytics, artificial intelligence (AI) and machine learning (ML) positioning and location features (e.g., position and location prediction), location precision and accuracy requirements, location and positioning privacy, unnoticeable positioning at the device, positioning and location based policy and charging rules, and other location based service requirements. Due to the complexity of the performed tasks which address different purposes, the network slice controller 126 may be composed by multiple orchestrators that independently manage a subset of functionalities of each layer. For example, the network slice orchestrator 128 may be an MT-LaaS based services orchestrator that independently manages functionalities of the LMF 131. To fulfill the service requirements, the various orchestration entities may coordinate with each other by exchanging high-level information about the state of the operations regarding the LMF 131 involved in the slice creation and deployment.

Turning attention more particularly now to the MT-LaaS 110, it serves to provide location data for one or more target devices 107 at the request of a tenant 106. The MT-LaaS 110 may store the location data it collects as Location Data Records (LDRs) 119 associated with each UE 107 monitored for each tenant 106. The MT-LaaS will share the LDRs 119 with the relevant tenant 106 upon a valid request, such as through an API 140.

The tenants 106 may have several different uses cases for accessing location data of the UEs 107. Each tenant may have a different use case that dictates the MT-LaaS exhibits different attributes according to these use cases.

One example use case may be to provide location services, via a Non-Public Network (NPN), to a tenant 106-1 such as United Parcel Service (UPS). UPS may utilize the MT-LaaS 110 to track the location of a fleet of delivery vehicles within a particular geographic location. This service may need accuracy of tens of meters.

A second use case may involve a tenant 106-2 that wishes to monitor the location of robots on their factory floor. This tenant 106-2 may need location services deployed with very high accuracy, such as a few centimeters.

Yet another tenant 106-t may be a law enforcement agency. This tenant may wish to utilize a public wireless network 103, but wishes that any technology deployed to determine a position of a UE should not be detectable by the UEs 107 and that such technology does not depend on the UE itself having an operational Global Positioning System (GPS) function.

The MT-LaaS service 110 could also be operated by the same entity that provides the wireless network 103 or not. Therefore, it may be desirable for the tenants 106 to specify certain aspects of the wireless network layer 103 used to deploy the MT-LaaS 110.

For example the tenant may have separately arranged to use a public network such as one provided by a traditional Mobile Network Operator (MNO) (e.g., AT&T, T-Mobile, Verizon or Dish Network). Or the tenant 106 may have arranged to access a public network provided by a Mobile Virtual Network Operator (MVNO) (such as Google Fi, Mint, or Consumer Cellular). Or the tenant 106 may have access to a private wireless network 103 or private network core 124.

In other instances, a tenant 106 may have built its own private wireless network 103 or core 124 (at least in part) as disaggregated elements of an Open Radio Access Network (RAN) architecture. In this instance, the tenant 106 may have arranged to implement a virtualized DU 252, virtualized CU 253 and/or virtualized RIC 254 elements residing at private or public clouds such as Amazon Web Services or Oracle.

The RUs 251 preferred by the tenant 106 may operate on 5G spectrum or unlicensed 6G spectrum, or may be accessible via Citizen Band Radio Service (CBRS), or via some aggregation of such spectrum.

Regardless of how the wireless network 103 is implemented, it should be understood that the provider of the wireless network 103 elements may not itself provide the MT-LaaS service 110. Suitable access and authentication protocols such as through an API 140 may thus be provided so that the MT-LaaS service 110 can access, process and store appropriate location data it collects concerning the UEs 107. Any required roaming agreements may be arranged between the MT-LaaS 110 provider and the wireless network provider 103, or between the tenant 106 and wireless network provider 103, or by agreement among all three entities.

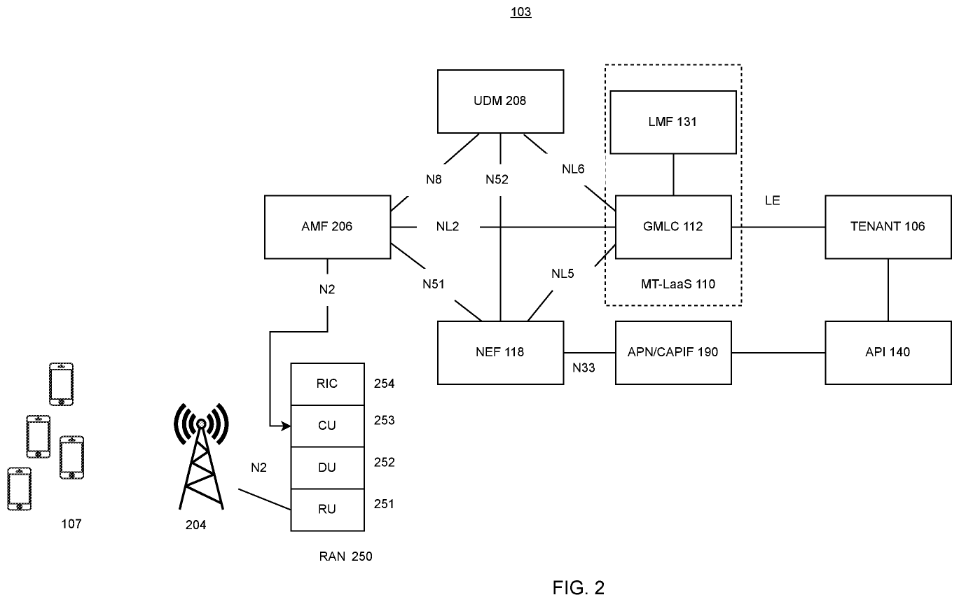

FIG. 2 is a more detailed diagram of a wireless network layer 103 that includes communication pathways between various wireless network functions and components for the MT-LaaS 110 in accordance with embodiments described herein.

In this embodiment, User Equipment (UE) 107 serviced by a tenant 106-n operates on a wireless network 103 that supports the customized MT-LaaS 110. The MT-LaaS may be layered onto a GMLC 112 and LMF 131. The network 103 may include a 5G New Radio (5G NR) Radio Access Node (RAN) 250 that may be implemented as an Open Radio Access Node. The RAN 250 may include disaggregated functions such as a Radio Unit (RU) 251, Distributed Unit (DU) 252, and Central Unit (CU) 253 which collectively implement the functions of a 3GPP Evolved NodeB (eNB) or New Generation NodeB (gNB).

With this architecture, the RU 251 is the radio unit that handles the digital front end (DFE) and lower parts of the Physical Layer, as well as the digital beamforming functionality. The DU 252 is a distributed unit that sits close to the RU 251 and runs functions such as Radio Link Control (RLC), Media Access Control (MAC), and the upper parts of the Physical layer. The CU 253 serves as a centralized unit that runs the Radio Resource Control (RRC) and Packet Data Convergence Protocol (PDCP) layers and other functions. A CU with multiple DUs may support multiple RUs. The CU 253 is thus a logical node that includes the gNB functions such as transfer of user data, mobility control, RAN 250 sharing, positioning, and session management. O-RAN also defines a standardized Radio Access Network (RAN) intelligent controller (RIC) 254.

The RAN 250 provides access to the 5G core (5GC) 124 and various other 5G NR network functions, including 5G Location Service (LCS) functions. LCS is a technology by which the elements of a 5G network 103 such as that shown in FIG. 2 may determine the geographical location of UEs 107, by transmitting and/or detecting wireless signals. The base station (e.g., RAN 250) is connected with the rest of the 5G core network based on an N2 interface and transmits location messages or measurements between the LMF 131 and RANs 250 through the AMF 206 or between the LMF 114 and the UE 107.

The AMF 206 performs UE 107 registration management, reachability management, connection management and mobility as per the 3GPP 5G standard.

Also shown are a Unified Data Management (UDM) service 208 that manages user data and the Network Exposure Function (NEF) 118. The NEF 118 is responsible for managing external open network data. External applications that request access to internal data of the 5G core pass through the NEF 118. In an example embodiment, an API 140 of an external location based services application, such as MT-LaaS may access position data associated with the UEs 107 (e.g., a geographical location of one or more of the UEs 107) through the NEF 118 via interface N33. This access may be according to policies, such as and charging rules specific to the tenant and/or network slice with which the UE 107 is operating. Such positioning data associated with the UE 107 may be further provided or configured by attributes of the MT-LaaS service 110 specific to each tenant 106.

Also, a tenant 106 may specify attributes of the MT-LaaS 110 and position data of the UEs 107 (e.g., geographical position of the UE) via the GMLC 112 according to specific requirements of the tenant 106, such as the 5G core configuration. The GMLC 112 may then obtain such data from the LMF 131 using the specific network core configuration requested.

The MT-LaaS 110 therefore may exhibit tenant-specific behaviors depending on these attributes. The tenant may select these attributes depending on its different use cases. The use case may dictate customized location based services or location data defined specifically for the use case and the type of core network that services the UE 107 of interest.

In an example embodiment, each tenant 106 receives the positioning service based on a certain set of policy configurations defined between the provider of wireless network 103 and the provider of the MT-LaaS 110. In various embodiments, these policies may specify that the MT-LaaS use different location technologies, or implement selected analytics features and capabilities, or provide access to different types of tenant specific positioning data, implement certain charging policies, provide specific OSS alarms and Key Performance Indicators (KPIs), implement certain data storage and retention policies, specify core options including network slicing options, and support tenant-specific APIs.

A first type of tenant 106 may be a delivery service such as United Parcel Service, who only needs location accuracy of ten meters, over an area covering a city. Any available location technologies may be acceptable for this tenant.

A second type of tenant 106 might be the owner of an automated factory where the UEs are robots. This tenant may need to track the location of the robots with centimeter precision, and to update location every second, but only needs coverage during its first shift working hours from 8 am to 5 pm. The MT-LaaS need only cover a particular city block.

However a different tenant such as a regulatory agency like a law enforcement agency, may only need position accuracy of several hundred meters, but does need to ensure that the MT-LaaS only uses a position technology that is not detectable at the UE 107, and that does not depend on the UE 107 having an on-board GPS. Such a tenant may wish the MT-LaaS to provide frequent updates, operate 24 hours per day, seven days a week until further notice, and over a large geographic area. This type of tenant may also require best in class security policies be applied to all communication.

As mentioned above, the MT-LaaS may be deployed to a specific tenant 106 using a specific slice of the wireless network layer 103. In particular, 5G network slicing functions may be used to define a set of logical networks on top of a shared wireless network 103 infrastructure. Each logical network is designed to serve a defined business purpose for a tenant and comprises the network resources, configured and connected end-to-end. Each slice is identified by a slice-ID, which may be Slice Selection Assistance Information (S-NSSAI) in a 5G network. However, many, but not all, of the 5G network functions (NFs) support network slicing. Currently, 3GPP has not yet specified network slicing for location based services, such as via a Gateway Mobile Location Center (GMLC) 112 node or for location based services network functions, such as the Location Management Function (LMF). Thus, the operator of the wireless network 103 may implement MT-LaaS 110 services customized for each tenant 106 and operating on a different slice of the network 103 for each tenant.

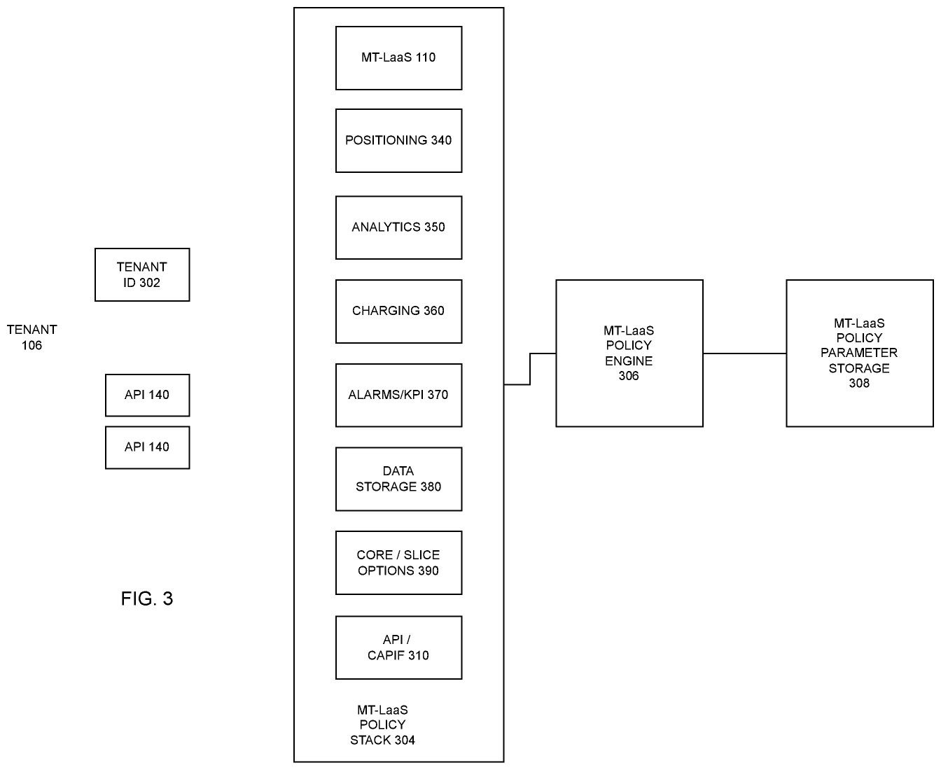

FIG. 3 illustrations example attributes of the services provided by the MT-LaaS 110 in more detail. Each tenant 106 may be associated with a tenant ID 302 which in turn identifies a policy stack 304 for that tenant 106. The policy stack 304 specifies one or more policies and/or attributes of the MT-LaaS for that tenant, including,
positioning technologies 340,
analytics 350,
charging policies 360,
alarms and Key Performance Indicators (KPIs) 370,
storage and retention policies 380,
network core and slice options 390, and
tenant-specific API(s) delivery 310.

The policy stack 304 associated with each Tenant-ID 302 should be exposed by the MT-LaaS 110 to certain elements such as the GMLC 112 and LMF 131 in order for those network functions to meet each tenant's requirements.

A tenant positioning policy engine 306 (which could be implemented in the GMLC 112, or as a separate network function) may thus implement and maintains the tenant's desired positioning policy stack 304.

Policies for a specific tenant may be updated through APIs 140 with an MT-LaaS policy engine 306 or via the NEF 118 in accordance with a Service Level Agreement (SLA) with the MT-LaaS 110.

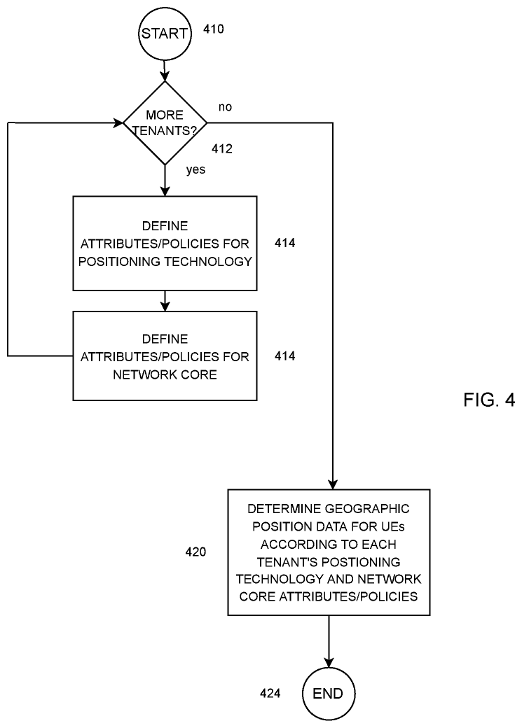

In other words, the MT-LaaS Policy Engine 306 implements the polices configured for each tenant 106, such as via communication with the GMLC 112/LMF 131 that supports the enumerated features. FIG. 4 is an example process flow for how the MT-LaaS Policy Engine 306. From a start state 410, a tenant 106 is identified in state 412. Next, in state 414, the attributes and/or policies of a positioning technology that is suited to the tenant's purpose is defined. This can be based on input from the tenant or by considering the type of tenant (e.g., by determining if the tenant of the type that prefers the positioning technology is not detectable at the UE). In state 414, attributes and/or policies of the network core for the tenant are determined. Again, this can be via input from the tenant or derived by knowing the type of tenant.

Processing then returns to state 412. If there are more tenants to process, state 414 is entered again. However, if all tenants are processed then a state 420 is entered, perhaps a some time later, where geographic position data can now be collected from the UEs according to each tenant's preferences. In state 424 the process may end.

It should be understood that the process of FIG. 4 is simplified and that other tenant-specific policies and attributes of the MT-LaaS service described herein may also be defined for each tenant.

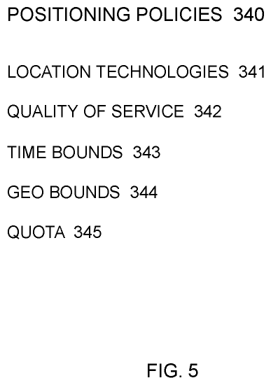

As mentioned above, the MT-LaaS 110 enables the tenant 106 to specify one or more positioning policies 340. As shown in FIG. 5 these positioning policies 340 may include a positioning technology 341, quality of service 342, time bounds 343, geography bounds 344 and quota 345.

Positioning technology attributes may enable the tenant to specify the physical mechanism for determining a position of the UEs 107 it wants to track. These may be online technologies (that are detectable by the UE 107) or offline technologies (that are not detectable by the UE 107). For example, certain tenants 106 such as law enforcement may only want to use positioning technologies that cannot be detected at the UE 107. One such positioning technology may be one that relies on measuring Round Trip Time (RTT) delay of several cells at the RAN 250 (MC-RTT). Various other network 103 based technologies may also include approaches such as Cell-ID, A-GPS, E-CID, DL-TDOA, UL-TDOA, AoA, AOD, (e.g., carrier phase in 3GPP Release 18). Device based positioning technologies may include A-GPS, Google ELS, Apple HELO, NextNav and the like which the UEs 107 participate in.

The location attributes 340 may also specify whether the tenant prefers a certain quality 342 of the location data, such as a particular accuracy or vertical positioning detail data.

Time bound attributes 342 may specify a time of day, days of the week, certain weeks or months during which the tenant requires the MT-LaaS 110 to operate. The time attributes 342 may also be periodic or triggered by an event.

Similarly, geographical based attributes 343 may specify an area over which positioning services are required by the tenant. This may be limited to specific city block, or campus or facility, zip code, metropolitan area, state, nation-wide or international.

Quota attributes 344 may be used to specify a quantity, frequency, and duration of location reports provided to the tenant.

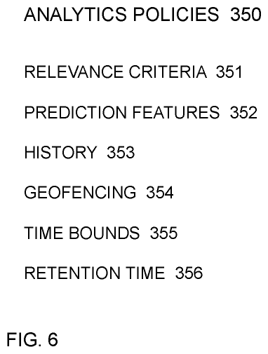

FIG. 6 illustrates example attributes of the analytics policies 350 that may be supported by the MT-LaaS 110.

In general, the MT-LaaS 110 may provide analytics on the positioning data it collects and provide these analytics to the tenant as well as or instead of the raw position data. Example attributes of relevance analytics may include capabilities using artificial intelligence or machine learning to predict the position of a specific target device in the future, or extracting meaningful insights from the history of the position of a specific device. Analytics may also include flagging an unusual position for a specific UE, or adjusting the retention time for certain positioning data depending on its significance.

These analytics may thus constitute an optimized selection or filtering of positioning data based on relevance criteria 351, or implement prediction 352, or be based on history 353. Events that are geography-bounded 354 or time bounded 355 may also factor into the analytics 355.

For example, prediction 352 implemented for a law enforcement tenant 106 may be able to leverage past observations that a certain UE 107 is likely to be at a particular location an hour from now.

A retention attribute 356 may specify how long the MT-LaaS should retain the analytics.

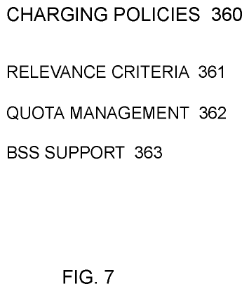

As explained previously, the MT-LaaS 110 creates and maintains Location Data Records (LDRs) 119 associated with each UE 107 according to an SLA agreed to for each tenant 106. FIG. 7 illustrates some of the charging policies 360 to be applied to the tenant's use of the MT-LaaS service 110.

Relevance criteria 361 may enable the tenant to specify that only certain aspects of the positioning data should be retained as relevant. For example, a tenant such as a local branch of UPS may have 2000 trucks in a particular city; however that UPS tenant may only want the MT-LaaS service to track position data for the trucks that are handling rush deliveries.

Quota management 362 may involve specifying a minimum or maximum number of positioning LDRs 119 maintained or a minimum or maximum number of positioning reports that will be made during a specific period of time.

In some embodiments, the charging policies 360 may be implemented via a Business Support System (BSS). In that case, the BSS attributes 363 may specify that the tenant requires access via such a BSS. The BSS may be used by the tenant 106 to for example, ensure that the MT-LaaS 110 implements certain features, such as security features, for any multi-tenancy implementation or network core that it utilizes.

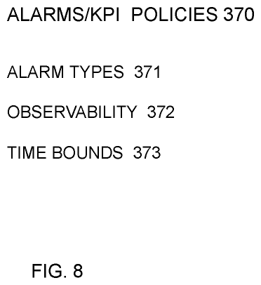

As shown in FIG. 8, each tenant 106 can also specify attributes 370 that relate to specific alarms, Key Performance Indicators (KPIs) or other observability features related to the MT-LaaS service 110. These attributes may depend on Operation Support System (OSS) policies as specified in the SLA between the tenant 106 and the operator of the MT-LaaS 107.

For example, the tenant 106 may be an MNVO that provides a public wireless network to a number of UEs 107. This type of tenant for the MT-LaaS may implement their own core network 103 but do not have positioning services to otherwise offer, instead contracting with the provider of the MT-LaaS 110. As a network operator, this type of tenant may want to have greater visibility into the performance of the MT-LaaS 110 than, say a tenant that is factory monitoring a small number of robots or other Internet of Things (IOT) devices.

Therefore, the types 371 of alarms and KPIs of interest may differ depending on the tenant's 106 preferences.

Observability 372 may another tenant-specific attribute. Some tenants may be enterprises that wish to have full observability of all operations provided for them, such as may be the case for a law enforcement tenant. In addition, some law enforcement tenants may only need to see some Key Performance Indicators (KPIs) regarding system performance. However, other tenants, e.g., an MNO or an enterprise may want to treat the MT-LaaS as their own captive positioning system. They may want to receive more reports such as fault and alarm metrics. They may want to diagnose faults to ensure the MT-LaaS can return to normal operation. In other instances, they may want to change the life cycle of a specific micro-service or working node associated with that tenant, and so forth.

These policies may also specify attributes of the alarms/KPIs such as a have a time bound 373. The time bound may specify that they are enabled based on a time of day, or day of the week, or periodically. For example, a factory tenant may only want alarms and KPIs active during a first shift production time scheduled only Monday through Friday from 9 am to 5 pm.

Example alarms may include whether aspects of the MT-LaaS service are functioning properly. For example, the tenant may want to see an alarm if a positioning function 340 is still operating, but the analytics 350 is currently off-line.

In another example, the MT-LaaS may currently only be able to provide KPIs at the end of the day, and the tenant 106 may want to be see an alarm when that reduced capability exists.

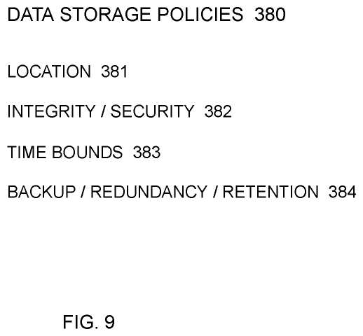

FIG. 9 depicts some of the possible storage attributes and policies 380 that may be applied to each tenant's Location Data Records (LDRs) 118.

A first policy 381 may specify a location for the storage of records. This may specify whether the LDRs 119 are retained in storage resources maintained by the provider of the MT-LaaS 110 or in remote storage resources otherwise accessible or maintained by the tenant 106 themselves.

Other attributes 382 may specify whether the MT-LaaS 110 supports integrity and security of the LDRs 119, and the type of such data integrity/security.

A time bound attribute 383 may specify how long the LDRs are retained by the MT-LaaS 110.

Backup and redundancy policies for the LDRs 119 may specify a mechanism for backing up the LDRs 119, how often such backups occur (such as daily or weekly), and other data protection/redundancy/data recovery attributes as desired by the tenant 106.

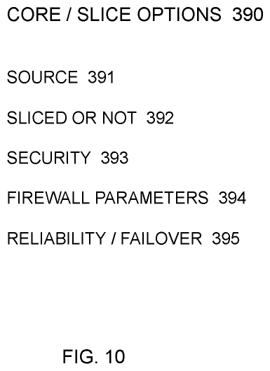

As mentioned previously, each tenant 106 may decide to specify certain aspects of the wireless network 103 core used to deliver the positioning service. As shown in FIG. 10, Core options policies 390 may thus specify attributes of this core network so that the MT-LaaS may integrate its functions accordingly.

For example, source attributes 391 may indicate that a tenant provides one or more of its own 5G core network functions, such as its own AMF 206, UDM 208, GMLC 112, RAN 250, etc) or whether the tenant 106 accesses these functions from an external vendor's 5G core. The tenant 106 may specify that it wishes the operator of the MT-LaaS to use these tenant-supplied 5G core elements.

In other instances, these attributes 391 may indicate the tenant use a combination of its own 5G core elements and elements provided by another core, such as from an MNO core otherwise accessible to the MT-LaaS 110 provider. For example, for reliability purposes, the tenant's own 5G core may be the primary network used for the MT-LaaS 110 services, with the MNO core network only used as a backup when the tenant's core is off-line.

Attribute 392 may indicate whether the tenant accesses these network functions via a slice of an external network or not. Slice attributes 391 may also indicate how to access the slice, such as via a “Slice-ID” (S-NSSAI) or via a group of slices (NSSAI), as explained already above.

In the case of using a 5G Core that is external to the MT-LaaS service, the tenant may specify security parameters 393 of the interfaces between the MT-LaaS 110 and the external 5G core at different layers. These may, for example, include indicating whether the external core network 103 supports protocols such as Layer 3 IPSec, Layer 4 TLS, Application Layer oAuth2.0, and so forth.

In the case of an external 5G core, firewall parameters 394 may also be specified by the tenant, in order to assist with protecting the MT-LaaS 110 from possible attacks.

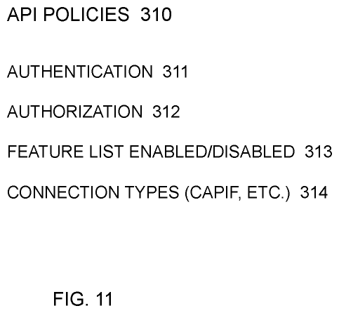

FIG. 11 shows some example attributes 310 for the Application Programming Interface(s) utilized by the MT-LaaS 110.

Authentication parameters 311 and authorization 312 parameters for the API may be based on the other agreed policies (such as positioning policies 340, analytics policies 350, data storage policies 370, etc).

The MT-LaaS API platform may also allow a tenant 106 to enable or upgrade\ or downgrade) the tenant's associated policies through a feature list 313 maintained as the API policies.

API connection type attributes 314 may be necessary if the MT-LaaS is to support multi-tenancy. This can enable each tenant to specify attributes of one or more APIs that it uses to access the LDRs 119.

These connection types may also support certain roaming scenarios. For example, an API could belong to a roaming partner, and connections to that roaming partner's platform should be supported.

Other API connection type attributes may specify that the API is provided via a 3GPP Common API Framework (CAPIF). The CAPIF may specify, for example, how the features of the MT-LaaS 110 are exposed to the tenant 106, that is, a mechanism for enabling the tenant 106 to access the MT-LaaS service 110.

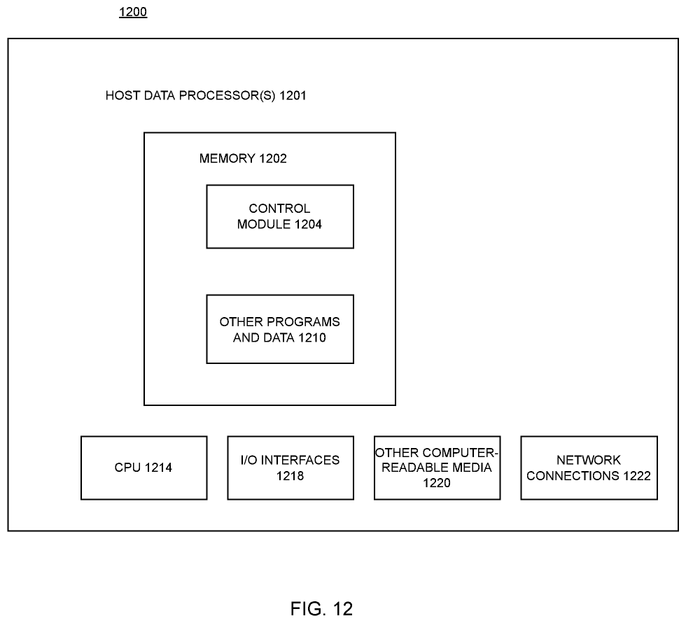

FIG. 12 shows a system diagram that describes an example implementation of underlying computing system(s) 701 for implementing embodiments described herein.

The functionality described herein for network slicing for multi-tenant location based services in a wireless telecommunication network can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may represent one or more of those in various data centers, base stations and cell sites shown and/or described herein that are, or that host or implement the functions of: routers, components, microservices, PODs, containers, nodes, node groups, control planes, clusters, virtual machines, NFs, and other aspects described herein for network slicing for multi-tenant location based services in a wireless telecommunication network. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems, components and modules described herein for network slicing for multi-tenant location based services in a wireless telecommunication network. Memory 1102 may also store other programs and data 1110, which may include rules, databases, application programming interfaces (APIs), policy and charging rules and data, OSS data, BSS data, software containers, nodes, pods, clusters, node groups, control planes, software defined data centers (SDDCs), microservices, virtualized environments, software platforms, cloud computing service software, network management software, network orchestrator software, one or more network slicing controllers, network functions (NF), artificial intelligence (AI) or machine learning (ML) programs or models to perform the functionality described herein, user interfaces, operating systems, other network management functions, other network functions (NFs), etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include location data interfaces, sensor data interfaces, global positioning system (GPS) interfaces, other data input or output interfaces, or the like. Other computer-readable media 1120 may include other types of stationary or removable computer-readable media, such as removable flash drives, Solid State Drives (SSDs), external hard drives, or the like.

The disclosure is also not limited by the name of each node described above, and in the case of a logical node or entity performing the above-described function, the configuration of the disclosure may be applied. In addition, the different logical nodes may be physically located in the same location or different locations, and may be provided with a function by the same physical device (e.g., a processor, a controller, etc.) or by another physical device. As an example, the function of at least one logical node described herein may be provided through virtualization in one physical device.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional states or steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may then execute the program code to perform the described tasks.

The above description has particularly shown and described example embodiments. However, it will be understood by those skilled in the art that various changes in form and details may be made therein without departing from the legal scope of this patent as encompassed by the appended claims.

1. A method for providing Multi-Tenant Location as a Service (MT-LaaS) in a wireless communication network, the method comprising:
for each tenant of a plurality of tenants of the MT-LaaS:
electronically defining, for each tenant, at least one attribute or policy for a positioning technology that is used by the MT-LaaS to determine geographic position data of one or more User Equipment devices (UEs);
electronically defining, for each tenant, at least one attribute or policy for a network core that is used by the MT-LaaS to provide customized location services; and
determining the geographic position data of the one or more UEs utilizing the positioning technology and network core electronically as defined for each tenant.

2. The method of claim 1 wherein the at least one attribute or policy for the network core specifies that the network core may be provided by a wireless network slice.

3. The method of claim 1 wherein a first service provider provides the MT-LaaS and a second service provider provides the network core.

4. The method of claim 1 additionally comprising:
electronically defining, for each tenant, one or more storage attributes or policies for the geographic position data.

5. The method of claim 1 wherein the at least one attribute of the positioning technology includes whether the positioning technology is observable by the UEs.

6. The method of claim 1 wherein the at least one attribute of the positioning technology is one or more of Multi-Cell Round Trip Time (MC-RTT), Cell-ID, E-CID, DL-TDoA, UL-TDoA, AoA, AOD, A-GPS, Google ELS, Apple HELO, and NextNav.

7. The method of claim 1 additionally comprising:
electronically defining, for each tenant, additional attributes or policies of the MT-LaaS related to one or more of analytics, charging, alarms, key performance indicators, or geographic position data protection and retention.

8. The method of claim 1 additionally comprising:
operating a Gateway Mobile Location Center (GMLC) node of the wireless communication network that supports network slicing; and
operating a Location Management Function (LMF) of the wireless communication network that supports network slicing.

9. The method of claim 1 wherein the at least one attribute or policy for the network core specifies at least one attribute or policy for disaggregated elements of an Open Radio Access Network and whether at least one disaggregated element is operated by the tenant.

10. The method of claim 1 additionally comprising:
electronically defining an Application Programming Interface (API) for use by the tenant to interact with the MT-LaaS via a Common Application Programming Interface Function (CAPIF).

11. A system for providing Multi-Tenant Location as a Service (MT-LaaS) in a wireless communication network, the system comprising:
at least one memory that stores computer executable instructions; and
at least one processor that executes the computer executable instructions to cause actions to be performed, the actions including:
for each tenant of a plurality of tenants:
electronically defining, for each tenant, at least one attribute or policy for a positioning technology that is used by the MT-LaaS to determine geographic position data of one or more User Equipment devices (UEs);
electronically defining, for each tenant, at least one attribute or policy for a network core that is used by the MT-LaaS service to provide customized location services; and
determining the geographic position data of the one or more UEs utilizing the positioning technology and network core electronically as defined for each tenant.

12. The system of claim 11 wherein the at least one attribute or policy for the network core specifies that the network core may be provided by a wireless network slice.

13. The system of claim 11 wherein a first service provider provides the MT-LaaS and a second service provider provides the network core.

14. The system of claim 11 wherein the one or more actions further comprise:
electronically defining, for each tenant, one or more storage attributes or policies for the geographic position data.

15. The system of claim 11 wherein the at least one attribute of the positioning technology includes whether the positioning technology is observable by the UEs.

16. The system of claim 11 wherein the at least one attribute of the positioning technology is one or more of Multi-Cell Round Trip Time (MC-RTT), Cell-ID, E-CID, DL-TDoA, UL-TDOA, AoA, AOD, A-GPS, Google ELS, Apple HELO, and NextNav.

17. The system of claim 11 wherein the one or more actions additionally comprise:
electronically defining, for each tenant, additional attributes or policies of the MT-LaaS related to one or more of analytics, charging, alarms, key performance indicators, or geographic position data protection and retention.

18. The system of claim 11 wherein the one or more actions further comprise:
operating a Gateway Mobile Location Center (GMLC) node of the wireless communication network that supports network slicing; and
operating a Location Management Function (LMF) of the wireless communication network that supports network slicing.

19. The system of claim 11 wherein the at least one attribute or policy for the network core specifies at least one attribute or policy for disaggregated elements of an Open Radio Access Network and whether at least one disaggregated element is operated by the tenant.

20. The system of claim 11 wherein the one or more actions additionally comprise:
electronically defining an Application Programming Interface (API) for use by the tenant to interact with the MT-LaaS via a Common Application Programming Interface Function (CAPIF).
